(19) United States
(12) Patent Application Publication
(10) Pub. No.: US 2025/0257944 A1
(43) Pub. Date: Aug. 14, 2025

(54) PLANT FOR WOOD MACHINING

(71) Applicant: IMAL S.r.l., Modena (MO) (IT)

(72) Inventor: Paolo BENEDETTI, Modena (MO) (IT)

(73) Assignee: IMAL S.r.l., Modena (MO) (IT)

(21) Appl. No.: 18/992,252

(22) PCT Filed: Jul. 21, 2023
(86) PCT No.: PCT/IB2023/057445

§ 371 Date: Jan. 8, 2025

(30) Foreign Application Priority Data
Jul. 22, 2022 (IT) 102022000015528

(51) Int. Cl. F26B 25/00; F26B 3/06; F26B 17/04

(52) U.S. Cl. CPC F26B 25/006; F26B 3/06; F26B 17/04; F26B 2200/24

(57) ABSTRACT

A plant for wood machining, comprises: a plurality of user points with a respective exhaust duct of the fumes to be filtered; at least one piece of equipment comprising at least one hollow filtering chamber defining at least one internal volume and comprising a filter or a filtering device/apparatus/unit/component/equipment/structure or the like of the fumes to be filtered to obtain filtered fumes housed at least partly in the internal volume, the filtering chamber being provided with: one inlet port and one outlet port of woody material; at least one introduction opening of the fumes to be filtered communicating with the exhaust ducts; and at least one evacuation opening of the filtered fumes towards the outside; wherein the fumes drying the woody material in its passage the inlet port towards the outlet port.

### TECHNICAL FIELD

The present invention relates to a plant for wood machining.

### BACKGROUND ART

With particular reference to the wood supply chain, the need to reduce as much as possible the amount of pollutant compounds released into the atmosphere as a result of the treatment and processing of this material is particularly felt nowadays.

It is well known, in fact, that numerous phases (e.g., drying, resin-coating, firing and so on) of wood machining produce, as a waste by-product, a certain volume of toxic fumes containing unburned powder and gases (e.g., carbon monoxide and volatile organic compounds known by the acronym “VOCs”).

The chemical composition and density of pollutants present in such fumes do not allow for their direct release into the atmosphere and therefore require that they first be properly treated and filtered.

For this purpose, the use of filtering devices of the type of centrifugal powder collectors, commonly known as “cyclones” is very widespread.

The aforementioned devices make it possible, in particular, to purify these fumes at least partly due to their centrifugation and the subsequent separation of the solid corpuscles and powder suspended in them.

It should be specified, however, that the filtering effect exerted by the cyclones makes it possible to remove only a limited amount of the pollutants in the fumes.

This means, therefore, that most of the powder and pollutants still remain in suspension in the fumes even as a result of their treatment by means of cyclones, keeping the fumes still highly toxic.

### DESCRIPTION OF THE INVENTION

The main aim of the present invention is to devise a plant for wood machining which allows effectively filtering the fumes produced in the various phases of wood processing while recovering the heat from the fumes themselves. Another object of the present invention is to devise a plant for wood machining which can overcome the aforementioned drawbacks of the prior art within the framework of a simple, rational, easy and efficient to use as well as cost-effective solution.

The aforementioned objects are achieved by this plant for wood machining having the characteristics of claim 1.

### BRIEF DESCRIPTION OF THE DRAWINGS

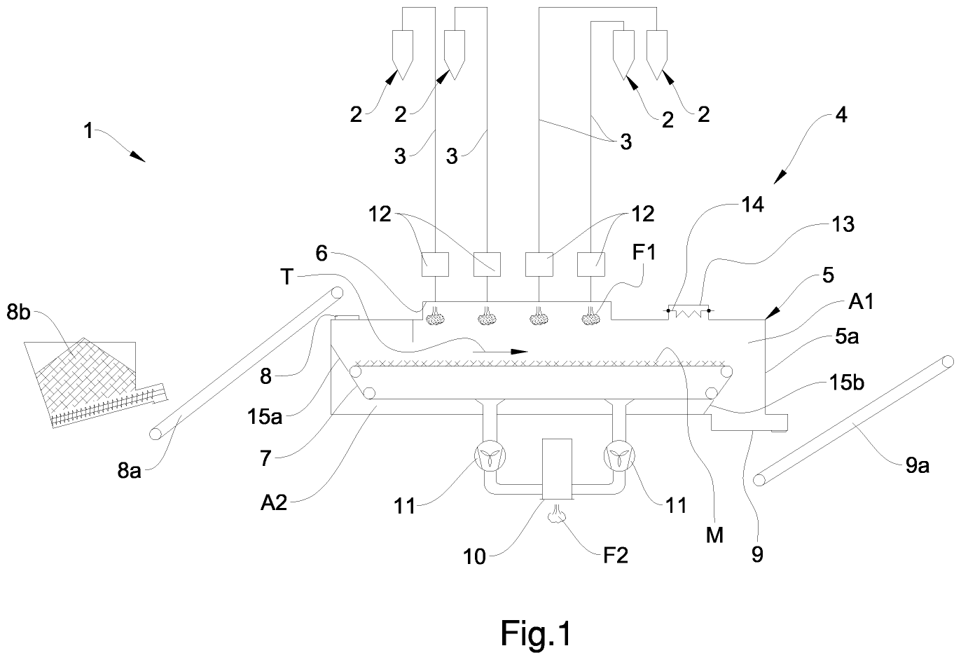

Other characteristics and advantages of the present invention will become more apparent from the description of a preferred, but not exclusive, embodiment of a plant for wood machining, illustrated by way of an indicative yet non-limiting example in the accompanying tables of drawings in which FIG. 1 is a schematic representation of the plant according to the invention.

### EMBODIMENTS OF THE INVENTION

With particular reference to these figures, reference numeral 1 globally refers to a plant for wood machining.

First of all, the plant for wood machining 1 comprises a plurality of user points 2 separate from each other, wherein one or more of the user points 2 is adapted for the treatment of woody material.

Thus, the user points 2 are provided with relevant inlet gaps of the woody material to be treated and with relevant outlet gaps of the treated woody material, which are not shown in detail in the figures.

In the present case, each of the user points 2 is provided with a respective exhaust duct 3 of the fumes to be filtered F1.

In this regard, it is specified that the fumes to be filtered F1 have a temperature substantially comprised between 10° C. and 150° C.

Again, it is also specified that the term “user points” refers to any plant, appliance and/or machinery intended to carry out one or more machining phases on woody materials (e.g., drying, resin-coating, forming, pressing, trimming, sanding and so on) and such as to generate the aforementioned fumes to be filtered F1.

It cannot, however, be ruled out that the term “user points” can also be referred to a plant, appliance and/or machinery intended for other purposes than those just described but such as to generate, nevertheless, the fumes to be filtered F1. According to the invention, the plant 1 comprises at least one piece of equipment 4 for filtering the fumes to be filtered F1 connected to the exhaust ducts 3.

Specifically, the piece of equipment 4 comprises at least one filtering chamber 5 defining at least one internal volume 5a for the treatment of the fumes to be filtered F1.

The filtering chamber 5 is provided with at least one introduction opening 6 of the fumes to be filtered F1 communicating with the exhaust ducts 3.

After being conveyed from the user points 2 towards the filtering chamber 5, then, the fumes to be filtered F1 are channeled into the internal volume 5a by passing through the introduction opening 6.

As a result of their introduction into the internal volume 5a, therefore, the fumes to be filtered F1 can be suitably filtered so as to obtain filtered fumes F2 to be released into the atmosphere.

Just in this sense, the filtering chamber 5 comprises filtering means 7 housed in the internal volume 5a.

Preferably, the filtering means 7 are arranged below the introduction opening 6. As anticipated, the filtering means 7 are adapted to filter the fumes to be filtered F1 in order to obtain the filtered fumes F2.

The filtering means 7 are adapted to allow the passage of the aeriform component of the fumes to be filtered F1 and to retain the solid polluting particles or micro-particles contained therein (such as, e.g., the volatile organic compounds known by the acronym “VOCs”).

Before further detailing the filtering means 7, however, it should be added that the filtering chamber 5 is provided with at least one inlet port 8 and with at least one outlet port 9 of woody material M in the form of flakes and/or powder.

In particular, the flakes and/or powder from the woody material M (commonly known as “chips” or shavings) can be produced, e.g., by means of preliminary treatments of the woody material itself by chipping and/or shredding.

The fumes F1, F2 are adapted to dry the woody material M, thus depriving it at least partly of its wet component, during its transfer from the inlet port 8 to the outlet port 9.

It is important to note in this regard that the inlet port 8 and the outlet port 9 are separate and not communicating with the user points 2.

Therefore, the plant 1 has no pipes or ducts connecting the inlet port 8, the outlet port 9 and the user points 2.

In other words, the woody material that passes through the filtering chamber 5 and which is passed through by the fumes F1 and F2 is separate from the material which is treated in the user points 2.

Thus, the inlet port 8 is isolated from the outlet gap of the user points 2 and the outlet port 9 is isolated from the inlet gaps of the user points 2.

Therefore, the plant 1 has no connections between the inlet port 8 and the outlet gaps of the user points 2 and between the outlet port 9 and the inlet gaps of the user points 2.

Therefore, the woody material M which is introduced into the filtering chamber 5 does not come from the user points 2 and, similarly, the woody material M that is extracted from the filtering chamber 5 is not conveyed within the user points 2.

In detail, the inlet port 8 and the outlet port 9 are arranged in opposite positions to each other on the filtering chamber 5. Again, the filtering means 7 are positioned between the inlet port 8 and the outlet port 9.

Regarding the outlet port 9, it is important to specify that it is separate and not communicating with the introduction opening 6 externally to the filtering chamber 5.

To say this is to state that the outlet port 9 and the introduction opening 6 are in no way externally connected to the filtering chamber 5 and which are, therefore, exclusively connected to each other in a fluid-operated manner within the filtering chamber 5 (see FIG. 1 in this regard).

In other words, the plant 1 has no pipes, ducts or similar connecting fittings to allow setting the outlet port 9 in communication with the introduction opening 6 externally to the filtering chamber 5.

The insertion of the woody material M through the inlet port 8 can be done manually by one or more operators.

Alternatively, in accordance with the preferred embodiment shown in FIG. 1, one or more conveying devices 8a can be provided to convey the woody material M towards the inlet port 8 in an automated manner.

In this latter case, the woody material M can be stored in an appropriate storage container 8b, the conveying device 8a taking the woody material M from the storage container 8b, by dosing and conveying it to the inlet port 8.

The conveying device 8a can be of various types; for example, the conveying device 8a can be of the type of a conveyor belt, or of the type of an auger, or of a “Redler” chain conveyor or of other types still known to the expert in the field.

Similarly, the woody material M coming out of the outlet port 9 can be transported in an automated manner from the outlet port itself towards a designated destination site (not shown in the figures for simplicity).

For example, this can be done through the use of one or more auxiliary conveying devices 9a positioned between the outlet port 9 and that destination site.

As in the case of the conveying device 8a, the auxiliary conveying device 9a can also be of various types; for example, the auxiliary conveying device 9a can be of the type of a conveyor belt, or of the type of an auger, or of a “Redler” chain conveyor, or of other types still known to the expert in the field.

As for the filtering means 7, in the preferred embodiment shown in FIG. 1, they comprise at least one conveying plane of the woody material M.

Specifically, the conveying plane 7 defines a direction of transport T of the woody material M directed from the inlet port 8 to the outlet port 9.

Appropriately, the conveying plane 7 is permeable to air and is adapted to retain solid particles (and/or micro-particles). Thus, the conveying plane 7 carries out mechanical-type filtering of the fumes to be filtered F1. More particularly, the conveying plane 7 is provided with a plurality of meshes intended to be crossed by the fumes F1, F2.

Preferably, the conveying plane 7 is of the type of a belt filter. In detail, the conveying plane 7 is positioned between the inlet port 8 and the outlet port 9.

As anticipated, the filtering means 7 are arranged inferiorly to the introduction opening 6; this results in the woody material M conveyed on the conveying plane 7 being lapped by the fumes to be filtered F1, ending up to be impregnated with the solid polluting particles that make up the latter.

Thus, the fumes to be filtered F1 yield at least part of their solid polluting particles to the woody material M which, in doing so, operates in conjunction with the conveying plane 7 in filtering the fumes to be filtered F1 from their toxic components.

The filtering action of the fumes to be filtered F1 is therefore carried out by the combined action of both the filtering means, specifically the conveying plane 7, and the woody material M arranged thereon.

Therefore, the fumes to be filtered F1 passing through the conveying plane 7 dry, in addition, the woody material M arranged thereon.

In fact, since the fumes to be filtered F1 are characterized by high temperature they result, as an ancillary effect, in the drying of the woody material M during the forward movement of the latter from the inlet port 8 to the outlet port 9. After passing through the filtering means 7, the resulting filtered fumes F2 can be conveniently expelled from the filtering chamber 5 and come, thus, into the outdoor environment.

In this regard, the filtering chamber 5 comprises at least one evacuation opening 10 of the filtered fumes F2 to the outside.

Specifically, the evacuation opening 10 is arranged on the filtering chamber 5 at an opposite position to the introduction opening 6 and the filtering means 7 are placed between the introduction opening 6 and the evacuation opening 10.

In actual facts, the filtering means 7 are placed both between the introduction opening 6 and the evacuation opening 10 and between the inlet port 8 and the outlet port 9.

Preferably, the evacuation opening 10 is arranged below the conveying plane 7. So, the evacuation opening 10 and the introduction opening 6 are arranged below and above the conveying plane 7, respectively.

It follows that the fumes F1, F2 pass through the internal volume 5a going from the top to the bottom.

The opposite case cannot however be ruled out wherein the evacuation opening and the introduction opening 6 are arranged above and below the conveying plane 7, respectively; in this case, therefore, the fumes F1, F2 pass through the internal volume 5a going from the bottom to the top.

To promote the expulsion of the filtered fumes F2 from the internal volume 5a, the filtering chamber 5 comprises at least one suction device 11 which is associated with the evacuation opening 10 and is adapted to draw in the filtered fumes F2 and to force them through the evacuation opening 10, evacuating them to the outside.

In detail, according to the preferred embodiment shown in FIG. 1, the filtering chamber 5 comprises two suction devices 11.

Preferably, the suction device 11 is of the type of a pneumatic fan or other type otherwise known to the technician in the field.

Usefully, the piece of equipment 4 comprises pre-filtering means 12 which are associated with at least one of either the exhaust ducts 3 or the introduction opening 6 and are adapted to carry out pre-filtering of the fumes to be filtered F1 before they enter the internal volume 5a.

It is clear how this expedient enables further abatement of the percentage of solid polluting particles present in the fumes F1, F2, purifying them even more effectively.

In this case, the pre-filtering means 12 comprise at least one mesh filter.

In this regard, it should be specified that the pre-filtering means 12 may comprise, in addition to or instead of the mesh filter, filters of a different type than the latter, such as, e.g., one or more bag filters or other filters still known to the expert in the field.

Advantageously, the filtering chamber 5 is provided with at least one access gap 13 communicating with the outside for the introduction of ambient air into the internal volume 5a.

It is important to specify that the access gap 13 is separate from the introduction opening 6.

This means, in practice, that the access gap 13 and the introduction opening 6 are separate from each other and not communicating externally with the filtering chamber 5.

Similar considerations on the meaning of “not communicating externally” previously made regarding the relationship between the outlet port 9 and the introduction opening 6 should be considered equally valid in the case of the access gap 13 and of the introduction opening 6, and are therefore not repeated. Therefore, the fumes to be filtered F1 and the ambient air mix with each other only when both access the internal volume 5a.

In this regard, the access gap 13 is placed in the proximity of the introduction opening 6, so that the ambient air can effectively mix with the fumes to be filtered F1.

Advantageously, the access gap 13 is arranged downstream of the introduction opening 6 with respect to the direction of transport T. This allows optimizing the energy and/or filtration efficiency inside the filtering chamber 5. This, in fact, promotes mixing between the fumes to be filtered F1 already introduced within the filtering chamber 5 and the ambient air introduced through the access gap 13.

Conveniently, the plant 1 comprises air heating means 14 associated with the access gap 13.

In particular, the heating means 14 are preferably of the type of radiators 14, but it cannot be ruled out that they may be of other types still known to the expert in the field.

In this regard, it should be specified that the filtering chamber 5 may comprise a plurality of access gaps 13 and a corresponding plurality of radiators 14 each associated with a respective access gap 13.

For example, the number of access gaps 13 and, therefore, of radiators 14 can be proportional to the drying temperature of the woody material M (i.e., the amount of water in the latter to be evaporated).

In other words, as the temperature and the amount of woody material M increase, several access gaps 13 and, therefore, several radiators 14 can be provided in the plant 1, and vice versa.

In this way, the fumes to be filtered F1 can be mixed with an amount of heated ambient air specifically calculated according to the woody material M to be dried and/or to the amount of water to be evaporated, allowing, evidently an even more effective drying of the latter.

Conveniently, the plant 1 comprises barrage means 15a, 15b positioned between the conveying plane 7 and the walls of the filtering chamber 5 and adapted to subdivide the internal volume 5a into:
at least a first area A1 communicating with the introduction opening 6 and intended to contain the fumes to be filtered F1; and into
at least a second area A2 communicating with the evacuation opening 10 and intended to contain the filtered fumes F2.

Specifically, the first area A1 is arranged below the second area A2.

In this way, it is possible to effectively channel the fumes to be filtered F1 through the filtering means 7 and, at the same time, easily evacuate the filtered fumes from the evacuation opening 10.

Specifically, the barrage means 15a, 15b comprise a first partition wall 15a and a second partition wall 15b arranged from opposite sides of the conveying plane 7.

Specifically, the first partition wall 15a is positioned upstream of the second partition wall 15b with respect to the direction of transport T.

Conveniently, the first partition wall 15a is arranged above the conveying plane 7 and the second partition wall 15b is arranged below the conveying plane 7. This prevents the fumes to be filtered F1 from escaping through the evacuation opening 10 without passing through the conveying plane 7 and the filtered fumes F2 from recirculating within the first area A1. Thus the passage of the fumes to be filtered F1 through the conveying plane 7 is forced.

Specifically, the first partition wall 15a is arranged in the proximity of the inlet port 8, while the second partition wall 15b is arranged in the proximity of the outlet port 9.

Again, the partition walls 15a, 15b are arranged at an angle and at an opposite slope to each other.

The particular arrangement of the partition walls 15a, 15b causes the conveying plane 7 to be positioned between the two areas A1, A2; therefore, in order to pass from the first area A1 to the second area A2, the fumes to be filtered F1 must necessarily pass through the conveying plane itself and be, in this way, filtered.

From what has been described so far, it is easy to appreciate how the barrage means 15a, 15b prove particularly useful in ensuring effective disposal of the filtered fumes F2 and, at the same time, proper filtering of the fumes to be filtered F1.

In fact, due to the fact that the fumes F1, F2 are isolated in their respective areas A1, A2, it is possible to ensure the expulsion of only the filtered fumes F2 outwards and the retention of the fumes still to be filtered F1 in the filtering chamber 5.

This fact makes it possible to avert unwanted evacuation of the fumes to be filtered F1 from the outlet port 9, dramatically increasing the efficiency and performance of the plant 1.

In accordance with another aspect of the invention, the present invention also relates to a process for wood machining.

Specifically, the process for wood machining comprises at least the following phases:
treatment of woody material in one or more user points 2 to obtain fumes to be filtered F1;
introduction of woody material M in the form of flakes and/or powder into a filtering chamber 5;
introduction of the fumes to be filtered F1 into the filtering chamber 5;
filtering the fumes to be filtered F1 inside the filtering chamber 5 to obtain the filtered fumes F2;
extraction of the woody material M from the filtering chamber 5, the fumes F1, F2 drying the woody material M introduced into the filtering chamber 5;
evacuation of the filtered fumes F2 externally to the filtering chamber 5 wherein the woody material M introduced into and extracted from the filtering chamber 5 is separate from the woody material treated in the user points 2.

In this regard, to say that the woody material M is not conveyed into the filtering chamber 5 from the user points 2 is to mean that the woody material located in the user points 2 is retained within the latter and is not, therefore, conveyed to the filtering chamber 5, where different woody material M instead is introduced for drying.

Conveniently, filtering comprises at least one conveying step of the woody material M on a conveying plane 7 of the filtering chamber 5.

Transport over the conveying plane 7 allows at least part of the pollutant compounds of the fumes to be filtered F1 to be yielded to the woody material M, resulting in filtered fumes F2 which are filtered from their toxic components which can be evacuated externally to the filtering chamber 5.

It has in practice been ascertained that the described invention achieves the intended objects.

In particular, the fact is emphasized that the special expedient of providing a piece of equipment for filtering the fumes to be filtered makes it possible to effectively filter the fumes generated by the user points, recovering the heat thereof to carry out drying of the woody material.

In this way, it is possible to use the dried woody material in a variety of different technical applications, such as e.g. within plants for the production of OSB panels, PB panels, pellets, pallets, or as fuel for boilers.

1. A plant for wood machining, comprising a plurality of user points separate from each other, wherein one or more of said user points is adapted for treatment of woody material, each of said user points being provided with a respective inlet gap of the woody material to be treated, with a respective outlet gap of the treated woody material and with a respective exhaust duct of fumes to be filtered (F1); the plant comprising:
at least one piece of equipment for filtering said fumes to be filtered which is connected to said exhaust ducts;
at least one hollow filtering chamber defining at least one internal volume and comprising filtering means of said fumes to be filtered to obtain filtered fumes housed at least partly in said internal volume, said filtering chamber being provided with:
at least one inlet port(s) and at least one outlet port of woody material in the-a form of flakes and/or powder, said inlet port and said outlet port being separate and not communicating with said user points;
at least one introduction opening of said fumes to be filtered communicating with said exhaust ducts;
at least one evacuation opening of said filtered fumes towards the outside; and
said fumes drying the woody material in a passage of the woody material from said inlet port towards said outlet port.

2. The plant according to claim 1, wherein the plant has no connections between said inlet port and said outlet gap of the user points and between said outlet port and said inlet gap of the user points.

3. The plant according to claim 1, wherein said filtering means comprise at least one conveying plane of the woody material along a direction of transport directed from said inlet port towards said outlet port, said conveying plane being permeable to air and adapted to retain solid particles and being located between said introduction opening and said evacuation opening so as to be passed through by said fumes to be filtered, said woody material drying during the forward movement towards said outlet port.

4. The plant according to claim 3, wherein that said conveying plane is of a type of a belt filter.

5. The plant according to claim 3 4, wherein said introduction opening and said evacuation opening are arranged above and below said conveying plane, respectively.

6. The plant according to claim 1, wherein said piece of equipment comprises pre-filtering means which are associated with at least one of either said exhaust ducts or said introduction opening and are adapted to carry out pre-filtering of said fumes to be filtered.

7. The plant according to claim 6, wherein said pre-filtering means comprise at least one mesh filter.

8. The plant according to claim 3, wherein said filtering chamber is provided with at least one access gap communicating with the outside for an introduction of ambient air into said internal volume, said access gap being separate from said introduction opening.

9. The plant according to claim 8, further comprising: air heating means associated with said access gap.

10. The plant according to claim 8, wherein said access gap is arranged downstream of said introduction opening with respect to said direction of transport.

11. The plant according to claim 1, wherein said filtering chamber comprises at least one suction device which is associated with said evacuation opening and is adapted to draw in said filtered fumes and to force them through said evacuation opening, evacuating them to the outside.

12. The plant according to claim 3, further comprising: barrage means positioned between said conveying plane and walls of said filtering chamber and adapted to subdivide said internal volume into at least a first area communicating with said introduction opening and into at least a second area communicating with said evacuation opening.

13. The plant according to claim 12, wherein said first area is arranged above said second area.

14. The plant according to claim 12, wherein said barrage means comprise at least a first partition wall and at least a second partition wall arranged from opposite sides of said conveying plane.

15. The plant according to claim 12, wherein one of said partition walls is arranged in the proximity of said inlet port and the other of said partition walls is arranged in the proximity of said outlet port.

16. The plant according to claim 14, wherein said partition walls are arranged at an angle and at an opposite slope to each other.

17. The plant according to claim 14, wherein said first partition wall is arranged above said conveying plane and said second partition wall is arranged below said conveying plane.

18. The plant according to claim 17, wherein said first partition wall is positioned upstream of said second partition wall with respect to said direction of transport.

19 A process for wood machining, comprising at least the following phases:
treatment of woody material in one or more user points to obtain fumes to be filtered;
introduction of the woody material in a form of flakes and/or powder into a filtering chamber;
introduction of said fumes to be filtered into said filtering chamber;
filtering the fumes to be filtered into said filtering chamber to obtain said filtered fumes;
extraction of said woody material from said filtering chamber, said fumes drying said woody material introduced into said filtering chamber; and
evacuation of said filtered fumes externally to said filtering chamber, wherein
the woody material introduced into and extracted from said filtering chamber is separate from the woody material treated in said user points.

20. The process according to claim 19, wherein the woody material which is introduced into said filtering chamber does not come from said user points and the woody material which is extracted from said filtering chamber is not conveyed within said user points.

21. The process according to claim 19, wherein said filtering comprises at least one conveying step of the woody material on a conveying plane of said filtering chamber.
